(19) United States
(12) Patent Application Publication
(10) Pub. No.: US 2023/0259695 A1
(43) Pub. Date: Aug. 17, 2023

(54) Content Selection Platform

(71) Applicant: Referboard Marketing Pty Ltd, Victoria (AU)

(72) Inventor: Aaron Woolf, Victoria (AU)

(21) Appl. No.: 18/015,682

(22) PCT Filed: Jul. 15, 2021
(86) PCT No.: PCT/AU2021/050760

§ 371 Date: Jan. 11, 2023

(30) Foreign Application Priority Data
Jul. 15, 2020 (AU) 2020902434

(51) Int. Cl. G06F 40/166; G06F 16/958; G06V 10/74

(52) U.S. Cl. CPC G06F 40/166; G06F 16/958; G06V 10/74; G06Q 30/0277

(57) ABSTRACT

A content selection platform for selecting content for display on a webpage, comprising the steps of: identifying webpage data, webpage data being data presented on a webpage; analysing the webpage data; retrieving content related to the webpage data from a content database; and, providing the retrieved content in order that the retrieved content to be inserted into the webpage for display at a display position on the webpage.

### FIELD OF INVENTION

The present invention relates to a content selection platform, and in particular to a content selection platform for selecting content for display on a webpage.

### BACKGROUND

The world is changing and the modern consumer wishes to be able to engage with image and video content, and transact products contained within. With the rise of social media, consumers are inspired quicker and require gratification faster, leaving publishers struggling to keep up. Consumers are seeking new and innovative ways to be able to buy what they see in the content that inspires them to shop and are often creating workaround solutions.

Publishers are struggling to keep up in increasingly competitive spaces and are seeking new and innovative ways to engage with, and generate revenue from, their audience whilst retailers are struggling to attract high value customers who want their products, not the deals and discounts so often required in order to attract customers.

There exists an opportunity to help consumers get the products they see in the content; publishers to generate more revenue; and advertisers to be able to target consumers who want to buy their products. With privacy law changes there is an opportunity to provide these benefits without using consumer data.

### SUMMARY OF THE INVENTION

In a first aspect the invention provides a content selection platform for selecting content for display on a webpage, comprising the steps of:

identifying webpage data, webpage data being data presented on a webpage;
analysing the webpage data;
retrieving content related to the webpage data from a content database; and, providing the retrieved content in order that the retrieved content to be inserted into the webpage for display at a display position on the webpage.

Content is fetched in real time and provided in a response to allow the content to be displayed on the webpage with webpage data.

Preferably the step of analysing the webpage data comprises the step of identifying at least one characteristic of the webpage data.

Preferably the step of retrieving content is performed by matching the webpage data with content stored within a content database to select and retrieve content related to the webpage data, the matching being performed based on the at least one identified characteristic of the webpage data.

Preferably the webpage data comprises at least one of: digital image data; digital video data; or, text data. If the webpage data includes digital image data, the characteristics may include items in the image. For example if the image is a photograph of an individual, the characteristics may include clothing items appearing in the photograph. If the webpage data includes text data, the characteristics may include keywords or themes in the text.

A content selection platform according to any preceding claim wherein the retrieved content comprises at least one of: product data; advert data; location data; contextual data; brand data; event data. Retrieved content is provided which relates to the identified webpage data. Embodiments may be used in advertising applications in order to present products on the webpage which are relevant to the content of the webpage. Users viewing the webpage are presented with products which are relevant to the content of the webpage that they are viewing. The retrieved content may include location relevant content. For example, if the webpage data relates to a specific location, then content may be provided which is relevant to the location. If a brand is relevant to the webpage data, brand content may be retrieved and provided for presentation on the webpage.

A content selection platform according to any preceding claim wherein the webpage data is an image, the image being analysed to identify characteristics within the image, the characteristics being associated with items in the image, the characteristics being matched to product data stored in the content database to identify product data associated with the items in the image, the matching product data being provided for display at a display position on the webpage. In embodiments product information may be provided which relates to items or products appearing in the image. Such embodiments are relevant to fashion applications. For example, if an image of an individual appears on a webpage then product content can be displayed alongside the image on the website to present a user with information or purchase options for products appearing in the image.

Preferably the analysis is performed by an image recognition algorithm. The image recognition algorithm is trained to identify clothing products within the image.

Preferably the step of identifying webpage data is performed in response to receiving a trigger signal. Preferably the trigger signal is generated in response to the website being accessed for display on a user device.

Preferably the steps of identifying the webpage data, analysing the webpage data, retrieving content and providing the retrieved content are performed dynamically upon receipt of the trigger signal. Such embodiments enable relevant content to be retrieved in real time and included into the webpage for display. This dynamic retrieval of content enables time relevant content to be displayed. For example, if a website is accessed during a brand sale, pricing and purchase links can be presented to the user which are relevant to the time at which the user is accessing the webpage.

Embodiments determine the location of the display position on the webpage.

Preferably embodiments include the further step of determining the position of the webpage data on the webpage, selecting at least a portion of the webpage data for analysis in dependence on the position of the portion of the webpage data with respect to the display position on the webpage of the retrieved content. Such embodiments account for the relative display positions of the content on the website with the presented products or other content provided by the content selection platform.

Preferably the portion of the webpage data selected for analysis is selected based on its proximity to the display position of the retrieved content. Some embodiments include the further step of determining the webpage data displayed within a viewport of a user device, and selecting the webpage data being displayed within the viewport of the user device for analysis.

Preferably the display position of the retrieved content on the website is within a viewport of the user device and the analysed webpage data and the retrieved content are displayed concurrently within the viewport of the user device.

Embodiments provide technology to create a connection between the content displayed on a webpage and content available for display on the webpage. The content may be data identifying products for sale which relate to the content of the webpage, news articles or videos related to the content of the webpage, or adverts relating to the content of the webpage. This technology facilitates contextual linking of data in real time to display contextually relevant data. The dynamic response of the content selection platform provides real time retrieval of relevant content data during the loading of a webpage. The real time nature of the technology allows content to be provided which is relevant to the webpage content and displayed concurrently with the webpage content. One benefit provided by embodiments of the technology is that content is provided for display on a webpage without requiring personal data of a user. Embodiments select relevant content for display based on the webpage content being displayed to a user, rather than based on the personal data of a user. The technology provides a privacy friendly way of providing content for display on a webpage.

In a second aspect the invention provides, a content selection platform for selecting content for display on a webpage, comprising:

data retrieving server for identifying webpage data, webpage data being data presented on a webpage;
data analysis server for analysing the webpage data;
content matching server for retrieving content related to the webpage data from a content database; and, providing the retrieved content in order that the retrieved content can be inserted into the webpage for display at a display position on the webpage.

Preferably the content selection platform is a distributed computer system.

Preferably the step of analysing the webpage data comprises the step of identifying at least one characteristic of the webpage data.

In embodiments the step of retrieving content is performed by matching the webpage data with content stored within a content database to select and retrieve content related to the webpage data, the matching being performed based on the at least one identified characteristic of the webpage data.

In embodiments the webpage data comprises at least one of digital image data; digital video data; or, text data.

In embodiments the retrieved content comprises at least one of: product data; advert data; location data; contextual data; brand data; news article data.

In embodiments the webpage data is an image, the image being analysed to identify characteristics within the image, the characteristics being associated with items in the image, the characteristics being matched to product data stored in the content database to identify product data associated with the items in the image, the matching product data being provided for display at a display position on the webpage.

In embodiments the step of identifying webpage data is performed in response to receiving a trigger signal. Preferably the trigger signal is generated in response to the website has been accessed for display on a user device.

Preferably the steps of identifying the webpage data, analysing the webpage data, retrieving content and providing the retrieved content are performed dynamically upon receipt of the trigger signal.

Further embodiments include the further step of determining the position of the webpage data on the webpage, selecting at least a portion of the webpage data for analysis in dependence on the position of the portion of the webpage data with respect to the display position on the webpage of the retrieved content.

Preferably the portion of the webpage data selected for analysis is selected based on its proximity to the display position of the retrieved content.

Embodiments include the further step of determining the webpage data displayed within a viewport of a user device, and selecting the webpage data being displayed within the viewport of the user device for analysis.

In embodiments the display position of the retrieved content on the website is within a viewport of the user device and the analysed webpage data and the retrieved content are displayed concurrently within the viewport of the user device.

In a third aspect the invention provides, a content selection platform for selecting content for insertion on a webpage, comprising the steps of: receiving data identifying an image on webpage; retrieving content related to the image from a content database; providing the content to be inserted into the webpage for display at a display position.

In a further aspect the invention provides a content selection platform for dynamically selecting and loading content data onto a webpage, the content data being selected based on its relevance to content of the webpage.

In a fourth aspect the invention provides a content selection platform for selecting content for insertion on a webpage, comprising the steps of:

receiving data identifying an image on webpage;
retrieving content related to the image from a content database;
providing the content to be inserted into the webpage for display.

The data identifying the image may be a URL address for the image. The data identifying the image may be a digital image file of the image. The data identifying the image may be a binary-to-text encoded data (e.g. base64) or any other data formats.

Preferably the content is provided for display at a display position on the webpage where the image and the provided content are displayed concurrently.

Preferably the content is product information related to the image.

Preferably the data identifying an image is received from a ad server or directly from a webpage.

Preferably the content is retrieved using an image recognition algorithm which identifies objects within the image, and a matching algorithm for matching identified objects with content in a content database. The algorithms may be AI algorithms.

Embodiments of the invention make webpage images shoppable by selecting content, for example adverts or products associated with webpage images, to be loaded into the webpage for display. Preferably the content is displayed at a display position where it is displayed concurrently with the associated image.

In a fifth aspect the invention provides a content selection platform for selecting content for insertion on a webpage, comprising the steps of: receiving data identifying an image on webpage; retrieving content related to the image from a content database; providing the content to be inserted into the webpage for display at a display position.

Preferably the content is provided to be displayed on the webpage at a display position where the image and the provided content are displayed concurrently.

Preferably the provided content is at least one of product data, advert data, contextual data, or brand data.

Preferably the platform analyses the image to identify image content within the image, and retrieve content related to the image content for insertion into the webpage.

Preferably the platform analyses the image to identify image content within the image and retrieve content from a content database related to the image content for insertion into the webpage.

Preferably the platform analyses the image using AI algorithms to identify the image content and matches the image content with content in the content database.

Preferably the display position for selected content in the webpage is pre-defined.

Preferably the display position in the webpage is fixed.

Preferably the display position in the webpage is variable, the display position is arranged in a portion of the webpage currently being displayed to a user.

Preferably the display position is defined by a content window on the webpage. The content window is a software application integrated into the webpage. The content window may be an ad unit.

Preferably the platform receives data identifying the position of the image on the webpage and data identifying at least one display position on the webpage, the platform allocates selected content associated with the image to display positions which are concurrently displayed with the image.

Preferably the image and associated selected content are concurrently displayed on a video output of a user device, for example a computer screen, a mobile device screen, a mobile phone screen.

Preferably the display position in the webpage is variable, the platform selects a first content associated with a first image for display at the content window when the content window is displayed concurrently with the first image, and a second content associated with a second image for display in the content window when the content window is displayed concurrently with the second image.

Preferably as users scroll around the webpage and different images are displayed, selected content is updated to present relevant content for the images currently being displayed to the user. The invention provides a platform for allocating content for display on a webpage. Allocated so that the content is displayed concurrently with associated images.

Embodiments provide a platform which selects content for display on a webpage. Content is selected by associating content with images or other webpage data on the webpage. The content of the webpage data is determined using AI algorithm. Content of webpage data is matched against a content database to identify relevant content for display on the webpage.

Embodiments select content for display on a webpage at a positions based on content of the webpage, for example an image on the webpage. Adverts or other content associated with the image are displayed concurrently with the image.

Embodiments associate adverts, or other content, with webpage content and display those associated adverts concurrently with the image.

In a sixth aspect the invention provides a content selection platform comprising the steps of determining that an image within a webpage is currently being viewed by a user, retrieving content associated with the image from a content database, identifying a content window on the webpage concurrently displayed with the image to the user, insert the retrieved content into the content window for display concurrently with the image. The content may be product data, advert data, news article, video data or any other data associated with the image. Embodiments are not limited to providing content relevant to images on a webpage, instead any webpage content can be analysed and content relevant to the webpage content provided for display on the website.

In a seventh aspect the invention provides a content selection platform for selecting content for inclusion into a webpage comprising the steps of:
receiving webpage data including image data of images included within the webpage and ad block data of ad blocks presented in the webpage, the data including position data defining the display position on the webpage;
retrieving content associated with the images from a content database;
allocating the retrieved content to ad spot for display on the webpage, wherein content is allocated based on the display position on the page so that content associated with an image is displayed concurrently with the image.

### BRIEF DESCRIPTION OF THE FIGURES

In order that the invention be more clearly understood and put into practical effect, reference will now be made to preferred embodiments in accordance with the present invention. The ensuing description is given by way of non-limitative example only and is with reference to the accompanying drawings, wherein:

FIG. 1 shows system architecture in an embodiment.

FIG. 2 is an illustration of an example webpage.

FIG. 3 is a flow diagram showing the steps for identifying products to display on a webpage.

FIG. 4 is a flow diagram showing the steps for identifying products to display on a webpage.

FIG. 5 is an illustration of an example webpage.

FIG. 6 is an example of an example webpage.

FIG. 7 is a flow chart showing steps performed in an embodiment.

FIG. 8 is a flow chart showing steps performed in an embodiment having multiple images on a webpage.

FIG. 9 is an illustration of an example website.

### DETAILED DESCRIPTION

Referring to the drawings, there are shown embodiments of a content selection platform 300 for selecting content data to be provided for display on a webpage. The content data is selected from a content database and provided to a publisher server hosting the webpage for display on the webpage. The content data may be loaded and displayed within an ad unit integrated into on the webpage or displayed at another designated display position on the webpage.

The content management platform is configured to retrieve content displayed from the webpage. The content management platform analyses the retrieved content displayed and selects content data for display on the webpage which is relevant to the existing content of the webpage. Embodiments provide content which is relevant to material already included on the webpage. In example applications, advertising material can be selected and provided for display on the webpage which is relevant to the content of the webpage. This contextual selection facilitates brands and products to be presented in context at the point at which a user is viewing webpage images or webpage text relevant to the brand. This positioning of relevant product data within a user viewport concurrently with the webpage content provides an enhanced user experience and a significant advantage over existing advertising technology.

The content provided for display on the webpage may include image data or text data and may include clickthrough web links for display on the webpage, for example which provide the user with purchase options. The system operates dynamically and provides the user with relevant content.

Content selection platform 300 implements selection of content for display on the webpage. As described in more detail below, content selection platform 300 includes a content management module 310 which receives a notification to provide content for display on a webpage. The notification may comprise different forms. For example, the notification may be an API request. The notification is typically generated in response to a webpage being loaded on a user device. For example, the notification may be generated by an ad tag incorporated into the webpage HTML file.

The notification may include various data which is described in more detail below. For example, the notification may include the webpage URL, image URLs, information concerning the size of the user viewport and designated display position on the website for content.

Content management module 310 is configured to identify webpage content for analysis. Content management module is configured to determine the position at which the selected content is to be displayed on the webpage. The display position may be included within the notification or accessed by the content management platform by other means. Content management module is configured to identify the position of webpage content on the webpage relative to the position that the selected content will be displayed. Preferably, content management module selects webpage content for analysis which is located on the webpage within the same viewport as the display position of the selected content; which is located adjacent to the display position of the selected content on the webpage; and/or, in the proximity of the display position of the selected content on the webpage. The content management module may select content on the webpage which is closest to the display position of the selected content. By analysing webpage content which is displayed close to the display position of the selected content, this enables the selected content data presented on the webpage to be relevant to webpage content that is visible to a user concurrently within a user viewport. Content management module determines the content that is currently within the user device viewport and analyses that content. The webpage content selected for analysis may include image data, text data, video data or other data displayed on the webpage.

Content selection platform includes an analysis server 320 which is configured to analyse the Webpage content. Analysis server 320 determines characteristics of the webpage content. If the webpage content is image data, analysis server may execute image recognition algorthms to identify recognized objects, items, text or locations within the image. If the webpage content is text data, analysis server may implement text analysis algorithms to identify themes or keywords in the text. The algorithms may be AI algorithms. This analysis by the analysis server determines characteristics of the context of the webpage content. These characteristics are used to select relevant content to display on the webpage. Depending on the application, different categories of analysis algorithms may be used. For example, for fashion application, analysis algorithms may be used which are trained to identify fashion items within an image.

Matching server 350 is configured to use the characteristics of the webpage content to match content of the webpage with content data stored in content databases 330. For example, if analysis server 320 identifies various fashion items in a webpage image, for example a shoe, matching server 350 searches content databases to identify appropriate content from the content databases to display on the webpage. In the example of the fashion application, the matching server searches content database 340 for shoes which match the shoe extracted from the webpage image by the analysis server.

Matching server 350 is configured compare items in the content database with the items identified in the image by the analysis server 320 and rank the items in terms of their similarity. The more similar the items, the better the match. Typically content database includes product images but other content may also be including for matching with webpage content.

In an example in which a product may appear in an image on the webpage, content management module 310 analyses the image and identifies characteristics of at least one product in the image. The characteristics are matched against product images stored in content database 330. Matching server 350 may use a vector matching technique to match the images stored in the content database to the item retrieved from the webpage image. The most similar product images in the content database to the characteristics of the products in the webpage image are selected by matching server 350 for display on the webpage.

Product images in content database 330 are mapped to product data stored in product database 340. Product images are provided with a unique identifier. Corresponding product data stored in product database 350 carries an equivalent identifier to allow the product image to be mapped to the product data.

Product database 340 includes product information including, for example: product name; product price; product availability; product size; product colour; product country; product category. Product data within product database 340 is periodically updated to remain current. For example, product data may be pulled or pushed into product database 340 from retailer sites, affiliated platforms or other third party sites.

The product images from content database selected by matching server and associated product data is incorporated into a response notification. It may be incorporated into the notification using a URL to the product image and clickthough URL providing further product information. The response notification may be a API response. Content management module 310 provides the response notification to the publisher server. Publisher server then loads the product information into the ad unit for display on the webpage.

Content selection platform executes the steps dynamically on receipt of a notification. The notification is received at the time when a webpage is loading. The steps are performed by content selection platform quickly so that the product information is provided back to the publisher server and can be displayed into the webpage during the loading process. The realtime nature of the system allows dynamic delivery of relevant content to be provided to the webpage for display during loading. The benefit of the dynamic content retrieval is that time relevant content can be provided. For example, if a promotion is currently available, the promotional product data is retrieved from the product database during the content selection process and provided for display. Or, for example, if availability of a product is changing quickly, the up to date availability of the product is provided with the API response and could be displayed to the user in the ad unit

The contextual nature of the content provided by the content selection platform ensures that the product data is relevant to webpage data displayed in the proximity of the ad unit.

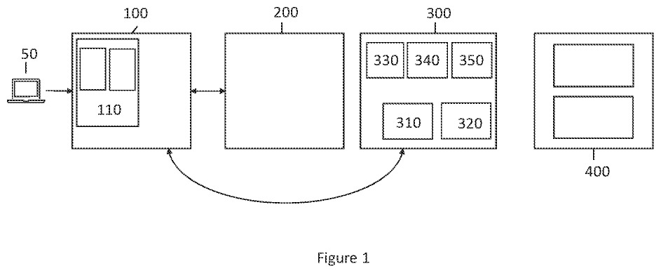

The product matching platform 300 communicates with other servers and components within a wider computer network architecture as shown in FIG. 1. The components are interconnected across a communication network, for example the internet. Content selection platform 300 is configured to communicate with publisher server 100 and an ad server 200, across a communication network. Content selection platform 300 may be connected to one or more databases 400 across the communication network. Such databases may include retailer product databases, brand databases or other databases providing products or other content.

The components of the network architecture are now described in more detail along with the functionality and interaction of the components.

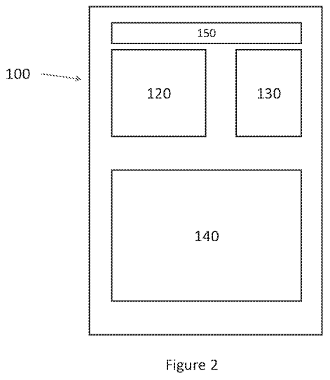

The network architecture of an embodiment of a system incorporating the content management platform 300 is shown in FIG. 1. Server 100 is a website server for storing webpage data for display to users on user devices across an internet connection. An example publisher webpage 110 is shown in FIG. 2.

FIG. 2 shows an example of a rendered webpage. Webpage 100 includes a number of components, namely, image 120, ad unit 130, text 140 and header 150. The webpage is structured which each component having a designated location on the webpage. Typically, webpage 110 may form one page of a larger website which includes multiple webpages. The content, layout and details of the webpage are defined by the HTML file for the webpage.

Webpage 110 is uniquely identified by an associated URL, being the address of the webpage. Image 120 typically also has an individual URL address, when it is stored as an independent file on the web. Typically when a URL is selected by a browser on a user device it directs the browser to the publisher server to retrieve the HTML file for rendering by the user browser.

The structure of the presentation of the webpage is defined by the content of the components and the positions of the components on the webpage. Each component, including the header 150, image 120, text block 140 and ad unit 130 has a designated location on the page. The location of each component is defined by coordinates on the webpage, stored within the HTML file. These coordinates may be provided in terms of pixels, for example, image coordinates 100 px, 1000 px, 900 px, 2000 px. The size of each component is also defined within the HTML file, for example 300×600.

The structure of the webpage, including the URLs, content, locations of the content on the webpage is stored in the HTML file defining the webpage.

The positions of the components may vary depending on the device or screen size rendering the webpage.

Ad unit 130 is an application integrated into the webpage 120. Ad unit defines an area of the webpage within which web content may be retrieved and displayed when the webpage is loaded. Content for display within the ad unit 130 is not specifically predefined. Instead, ad units are configured to receive and display content data within the ad unit when the webpage is loaded. This content data is provided by content management module 310 in response to a request by the user browser when the user browser loads the webpage.

Ad unit has an associated ad tag. Ad tag is code inserted within the HTML file that sends a request for content to be displayed in the ad unit. Ad tag is typically designated to a specific server for retrieving content. The ad tag defines further information about the ad unit. This may include size of the ad unit, location of the ad unit on the webpage, features of the ad unit, including default fonts, colours and other data relating to the style of the ad unit. Ad tag may include additional limitations on the type of content for display, for example text-only or image only.

When the webpage is loaded by a user browser, the ad tag is triggered to retrieve content for display in the ad unit. In an example embodiment when triggered, the ad tag creates an API request for content. The API request includes a request for content for display in the ad unit. The API request is sent to content selection platform 310 identified in the ad tag. Ad tag may include webpage data in the API request, for example ad unit coordinates, webpage URL, image URLs for images on the webpage. The included webpage data varies depending on how the ad tag is programmed.

When content selection platform 300 has identified relevant content for display in the ad unit, it sends an API response back to the ad tag. The API response includes data associated with the content for display in the ad unit. These data are loaded into the ad unit by the browser. As discussed, the data may include product information, image URLs, click through URLs and other data.

The content provided by the content selection module 300 includes, for example, product data or advert data, to be rendered within the ad unit on the webpage. The content may provide include click through URLs to redirect the browser to specific webpages associated with the adverts or other content.

Ad unit 130 may be positioned at a fixed location on the webpage or at a variable position on a webpage. In some cases, ad units can ‘float’ on the page. Floating ad units move up and down the webpage as a user scrolls through the webpage so that the ad unit remains within the viewport.

The webpage may be viewed on a video output or viewport of a user device, for example a computer screen, a mobile device, a mobile phone display or another display device. Webpages may be rendered differently on different devices due to screen size restrictions.

Ad server platform 200 is connected to website server 200 across a communication network. Ad server platform 200 is connected into the webpage server 100 and provides links to adverts or content directly to the website or via the ad server. The ad server platform can be ad server/network, demand side platforms (DSP) or hybrid, or any advertising technology platforms.

In an example where the publisher's webpage and the ad unit is configured to enable bids for access to the ad unit, the ad server is called by the publisher's website server when a user's browser accesses the publisher's website. Ad server typically enables advertisers to bid to place their ads in the ad unit on the webpage. The ad tag for the winning bidder is provided to the publisher's webpage and content is retrieved from the winning bidder's content management platform. The bidding process at the ad server is performed in real time.

Content management platform 300 includes a number of components, described in more detail above. Although the components are shown within a single platform in FIG. 1, they may be located in separate physical locations and connected across a communications network as a distributed compute system. Content management module 310 provides interface processing to website server 100.

Content management module 310 provides API responses and receives API requests. Requests and notifications may be received and issued in other forms other than API formats. Content management module 310 identifies and retrieves webpage data and content for analysis, including image data associated with images displayed on webpages. This webpage data may be fetched from website servers. The functionality of content management module 310 is described in more detail below.

AI Server 320 includes extraction algorithms, for example image extraction algorithms or text recognition algorithms. AI server receives image data from content management module, analyses the image and extracts image information from the image.

Content database 330 includes content images. Product database 340 is populated by products having external product information, for example URLs associated with retailer product feeds 410. Product information may include URL data identifying addresses where product data can be accessed, and other product data, including price, availability. Product identifiers uniquely define the product within product database 330 and are used to map product data in product database to product images in content database.

Content management module 310 includes matching server 350 for matching products stored within the product database with image information extracted from images by image extraction algorithms. Other content data, including video data and text data can be matched by matching server 350. Matching server may execute AI algorithms to match content within content database 330 with website content.

Content management module 310 includes product database 340 for storing product information associated with the product images stored within content database 330. Product information may include external links to redirect to retailer sites 420.

An example embodiment is now described in relation to a fashion related application.

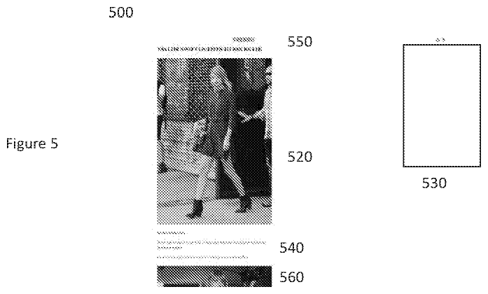

FIG. 5 shows a representation of a webpage 500 for display in a viewport on a user device. In FIG. 5 the webpage is shown as it might be rendered on a user device in which only a portion of the webpage is visible in the viewport at any time. Webpage 500 includes heading 550, image 520, text 540, a second image 560 and ad unit 530. As shown in FIG. 5, the second image 560 is only partially displayed to the user due to limited display size of the viewport. Image 560 could be brought into full view on the viewport by scrolling down the page to bring the image within the viewport.

In FIG. 5, the position of ad unit 530 is fixed on the webpage. Ad unit 530 has similar horizontal coordinates to image 520 and is presented at a similar horizontal position. When the webpage is rendered on a user display, ad unit 530 and image 520 are concurrently visible within the viewport.

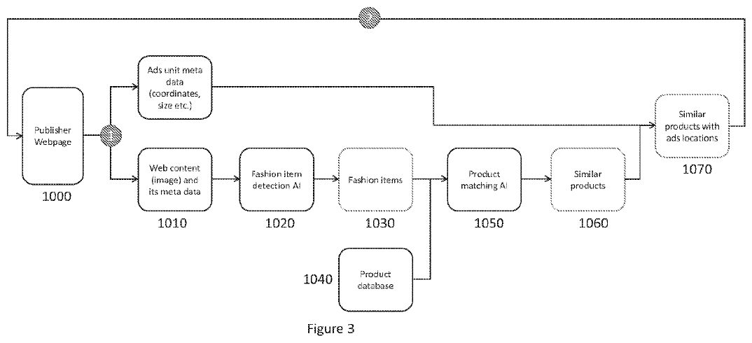

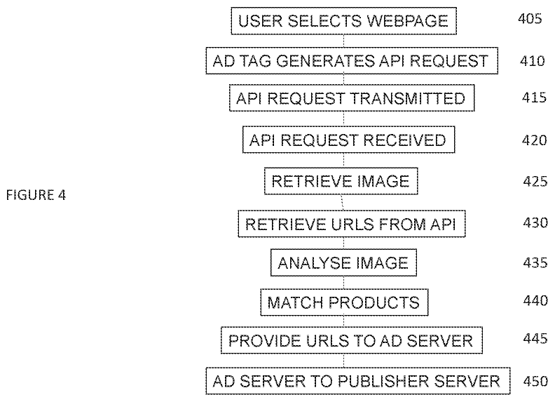

Referring now to the flow diagrams of FIGS. 3 and 4.

At 405 user input is received on a user device 50 and selects website 500 for display on user device 50. In response to the user input, at 410 user browser on the user device 50 accesses website server 100 and retrieves HTML file for webpage 500. User browser retrieves the page content and the ad tag associated with ad unit 530 from the HTML file for webpage 500. As described above, ad tag associated with ad unit 530 may be pre-loaded into the HTML file or may have been provided by ad server 200 after a bid request. At 410 user browser loads the webpage. Loading the webpage triggers ad tag to generate an API request to content selection platform 300.

API request provides data relating to the webpage. In the example below, API request includes URL of the images on the page, image data, image coordinates, ad unit size and ad unit coordinates. It will be clear that the data provided in the API in this example is one example implementation. In other implementations, different data may provided to the content selection platform.

The API request is:

″images″: {
″image1″: {
″image_url″: ″https://trendii
products.storage.googleapis.com/_trendii_images_/129/a39358c3f7993c3f1682c5ae70c499
b2.JPG?20200616″,
″image_coordinates″: ″100px, 1000px, 900px, 2000px″,
″ads_unit″: {
“size”: “300x600”
“coordinates”: ″100px, 1000px, 900px, 2000px″,
)

API request includes:

URL address for image 1 (https://trendii products.storage.googleapis.com/_trendii_images_/129/a39358c3f7993c3f1682c5ae70c499 b2.JPG?20200616)
Coordinates for image 1 (100 px, 1000 px, 900 px, 2000 px)
Size of ad unit (300×600)
coordinates for ad unit (100 px, 1000 px, 900 px, 2000 px).

Depending on the way the ad tag is configured different data may be incorporated into the ad tag. Typically, the location of the ad unit is included in the API request so the content selection platform 300 can determine where on the webpage its content will be displayed. Image data and or webpage URL is also included in the API request. This allows the content selection platform to identify content for analysis. Some systems may provide different data.

At 415 the API request is transmitted to content selection platform 300.

It will be appreciated that information about the webpage could be notified to the content selection module in different ways. The API described above is one example of a communication protocol. Other communication mechanisms are possible and within the scope of this invention.

At 420 content management module receives the API request. At 420, content selection platform receives information about content. Content management module recognizes the API request as a trigger to select and provide related content for display in an ad unit.

At 425, content management module identifies the webpage content within the API request. Content management module recognizes the URLs and extracts the URLs of the webpage and URLs of the images from the API request at 425. At 430 and 1010, content management module retrieves webpage data and image files using the URL addresses.

In the example provided above, the content management module 310 is provided an image URL. Content management module 310 access the URL links to retrieve the image data.

In further embodiments the content management module 310 is provided with the webpage URL, image URL and the ad unit coordinates. In such embodiments the content management module 310 scrapes the webpage to retrieve the image. For example:

```
{
  ″webpageUrl″:″https://www.dailymail.co.uk/tvshowbiz/article-9761703/Cannes-Film-
Festival-2021-Stars-arrive-Annette-opening-night-
premiere.html#https://i.dailymail.co.uk/1s/2021/07/06/17/45108703-9761703-
Stunning_Blanca_put_on_a_stunning_display_in_a_blush_pink_off_th-a-
46_1625589014692.jpg″,
  ″imageUrls″:[
    ″https://i.dailymail.co.uk/1s/2021/07/06/23/45121901-9761703-image-a-
72_1625611867990.jpg″
  ],
″ads_unit″: {
“size”: “300x600”
“coordinates”: ″100px, 1000px, 900px, 2000px″,
  ″publisherId″:″60b74492cad9572bb0169be2″
}
```

In this example content management server 310 is provided with webpage URL in addition to image URL and ads unit URL. Content management module 310 retrieves the full webpage data. Content management module determines the position of the ad unit, where its content will be loaded on the webpage, with respect to other content on the webpage. Content management module then selects content for analysis based on proximity of the webpage content to the ad unit.

In other embodiments the image file or other content data, for example, webpage text data may be provided within the API request. The data identifying the image may be a binary-to-text encoded data (e.g. base64) or any other data formats.

The data included in API request also depends on the type of ad tag associated with the web page. For a native ad tag, typically only the image URL is required since the content management module has control of the position of the ad unit. For programmatic ad tags additional information is provided including webpage URL, ad unit location and user device screen size.

After the image has been retrieved at the content management module 310, content management module performs the step of analysing the image at 435. In the example of FIG. 5, the image 520 is a photograph of a female. The image includes multiple items including dress, boots, bag.

In a first example method, the image and its metadata are retrieved at 430 1010. The image is provided to object AI server 320 at 1020. The image may be in any digital format, for example a Joint Photographic Experts Group (JPEG) format. AI server 320 runs object AI detection algorithms on the image to identify fashion items within the image. In the example of FIG. 2, the object detection AI is a specific fashion item detection AI trained to identified fashion objects within the image. In other embodiments, alternative object detection algorithms may be run on the image to extract different types of objects. Depending on the image or the requirements of the application, the algorithm may be trained to identify different types of items appearing in the image. For a location application, the algorithm is trained to identify landmarks or location information appearing in the image. This allows the content selection platform to recognize the context of the image.

Object detection AI algorithm scans the image and identifies characteristics associated with fashion items within the image. Typically these characteristic are predefined categories. Depending on the application, the algorithm may detect different characteristics representative of different items. The output from the algorithm includes meta data like bounding box and landmarks of items. The identified fashion items are cropped and saved into separated images. The product feature extraction AI algorithm then take those cropped item images and extract features like fashion item color, category, style and etc. from each image. Those features will be separated, presented and normalized in a machine-friendly way (a numeric vector) at 1030.

The algorithms may conduct probability analysis of the detected item to generate a probability score for the item in the image. For example, the content management module may identify an ankle boot in the image with high probability of, for example 83%. The higher the probability, the more certainty the content management system has that the item is correctly identified.

When items have been identified within the image at 435, the items are compared with products within a product database at 440 to identify matching products.

At 1050 the items detected within the image are matched to product images in content database 1040. At 1050, the vectors are passed to a similarity algorithm to calculate the distance/similarities between the query items and all product images stored within content database 1040. The similarity algorithm may be an AI algorithm. In some embodiments the database may include millions of product images. Images within content database 1040 are also all pre-indexed with vectors. Matching server 350 compares the items in the bounding box with images in the database and generates a similarity score. The higher the score, the higher the similarity and the better the match.

At 1060 the distance matrics will then be passed to a ranking algorithm to optimize the product recommendation and ranking. This step identifies the product images within the database most similar to the identified fashion items within the image. Ranking algorithm may be configured to rank product images according to different criteria. For example, the ranking algorithm may rank products based on style, colour, brand or other criteria.

The highest ranking product images are selected for display on the webpage. Content selection platform 300 identifies the identifier of each of the selected product images within content database 330. The identifier is mapped to product data stored in product database. Product data may include product name, product price, product availability, product size, and other data relevant to the product. Product data is retrieved and included in the API response.

URLs associated with the matching products are retrieved by the content management module. Typically, the URLs are provided within an API response. The products are sent to website server at 450 for incorporation into the ad unit and display on the webpage.

The identified products are transmitted back to the publisher server by the content management module at 1070 for presentation on the webpage. This data may be sent in the form of an API response. API response may include: image number, object number in a given image, product number in a given object and/or product details(image_url, name, price, product page link etc.). The products are identified by a product image URL which will be rendered when presented on the webpage in the ad unit for example:

image_url“:”https://trendii-products.storage.googleapis.com/_trendii_images_/129/a39358c3f7993c3f1682c5ae70c499 b2.JPG?20200616.

Additional information, including product information, for display by the ad unit may also be included in the API response. this additional information may include javascript and html codes to be run on publisher's website. Additional product information may be retrieved from external databases associated with the selected products or from product pages 340.

An example API response is as follows:

```
{
  “image1”: {
    “object1”: {
      “product1”: {
            “image_url”: “https://trendii-
products.storage.googleapis.com/_trendii_images_/129/a39358c3f7993c3f1682c5ae70c499
b2.JPG?20200616”,
          “product_name”: “1725.A Ankle boots”
              “old_price”: “”,
                  “new price”: “$254.04”
                    “product_url”: “https://trendii.com/2ca968be4761d93b2beb00cfd9d848ce/dd”,
                      “cashback”: “$10”
                },
        ...
```

In the example API response above additional information is provided for display in addition to the product url. In the example API response provided above multiple urls are provided in addition to the product name being provided for display along with price information and a further product URL:

product_url“:”https://trendii.com/2ca968be4761d93b2beb00cfd9d848ce/dd

The API response includes separate links to an image (for display in the ad unit):

https://trendii-products.storage.googleapis.com/_trendii_images_/129/a39358c3f7993c3f1682c5ae70c499b2.JPG?20200616; and also to a separate product URL https://trendii.com/2ca968be4761d93b2beb00cfd9d848ce/dd. This separate Product URL may be a click through weblink. This click through weblink is a selectable URL clickable by a user to a separate webpage. The weblink may redirected the browser to a retailer website from which the user may purchase the products or to an intermediary or reseller. Further API responses may include additional information.

Additional information included within the API response includes: the product name for display within the ad unit “Ankle boots”; price information, in the example API response the information includes an old price and new price “$254.04” for the product for display within the ad unit; and further promotional information, for example “cash back $10”.

Publisher webpage loads the API response and updates the integrated ad unit with the relevant information provided in the API response. In embodiments javascript will update content automatically according to where the user is at on the page.

The process described above with respect to FIG. 3 provides products for presentation on the webpage which are related to images on the webpage. The URLs of the products along with the product information provided enable the presented products to be clickable and shoppable by users. As described above preferably the products are rendered and displayed within dedicated applications integrated into the webpage, for example ad units.

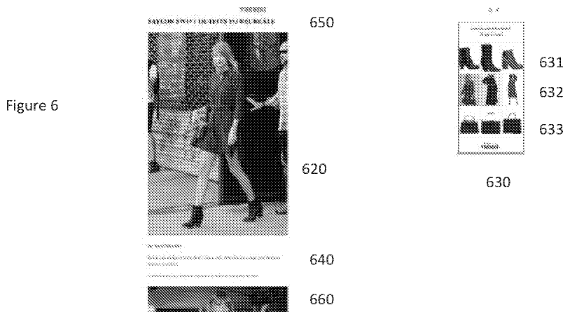

An example representation of a populated ad unit is shown in FIG. 6. The example of FIG. 6 represents the same webpage as shown in FIG. 5 but including the populated ad unit. In this example, on analysing image 620, the object AI detection system has identified the products ankle boots, dress and bag within image 620. For each of these products, matching server has identified three matching products for display within ad unit 630, so ad unit includes images of three ankle boots 631, three dresses 632, three bags 633. Each image within the ad unit may include clickable weblinks selectable by the user from the webpage. Selection of the image may redirect the user to a further webpage associated with the selected product. The webpage may be a product information page, a product purchase page. The web page may be hosted by a retailer or product manufacturer.

As described with respect to the example API response, additional information can be provided for inclusion into the ad unit. In the example of FIG. 6, the further information includes text confirming the significance of the products in the ad unit to the image on the webpage, “Love the look in the photo?” and “Shop it now!”. Branding and logos are also included within the ad unit. This additional information is provided within the API response.

In a further example, an API response includes multiple products for display in the ad unit, as follows:

```
{
    “success”: true,
  “payload”: [
      {
        “imageUrl”: “https://i.dailymail.co.uk/1s/2021/07/06/23/45121901-9761703-image-a-
72_1625611867990.jpg”,
        “products”: [
            {
              “id”: “2466124”,
              “name”: “Giambattista Valli - pleated midi dress - women - Silk/Cotton/Polyester -
40 - White”,
            “price”: “4477.00”,
              “sale”: true,
              “category”: “dress”,
              “currency”: “$”,
              “url”: “https://affiliate.trendii.com/affiliate-
link?affiliateId=310&utm_source=8d52c450-dee9-11eb-8943-
db8b0e077f69&utm_campaign=60daa49d02d0d9afec5ecdce&utm_term=2466124&utm
_content=60e4e23b1d55a42f0f198b4a&utm_medium=60b74492cad9572bb0169be2&re
directUrl=https%3A%2F%2Fprf.hn%2Fclick%2Fcamref%3A1101l9LGB%2Fcreativeref%
3A1101l18028%2Fdestination%3Ahttps%3A%2F%2Fwww.farfetch.com%2Fau%2Fshop
ping%2Fwomen%2Fgiambattista-valli-pleated-midi-dress-item-15075557.aspx”,
              “image”:
“https://cdn.trendii.com/_trendii_images_/310/abd41c0156d7c28c18ccb9876e607aef
.jpg”
          },
            {
              “id”: “2704180”,
              “name”: “Giambattista Valli - floral-embroidered pleated dress - women -
Silk/Cotton/Polyester - 44 - Blue”,
              “price”: “3212.00”,
              “sale”: true,
              “category”: “dress”,
              “currency”: “$”,
              “url”: “https://affiliate.trendii.com/affiliate-
link?affiliateId=310&utm_source=8d52c450-dee9-11eb-8943-
db8b0e077f69&utm_campaign=60daa49d02d0d9afec5ecdce&utm_term=2704180&utm
_content=60e4e23b1d55a42f0f198b4a&utm_medium=60b74492cad9572bb0169be2&re
directUrl=https%3A%2F%2Fprf.hn%2Fclick%2Fcamref%3A1101l9LGB%2Fcreativeref%
3A1101l18028%2Fdestination%3Ahttps%3A%2F%2Fwww.farfetch.com%2Fau%2Fshop
ping%2Fwomen%2Fgiambattista-valli-floral-embroidered-pleated-dress-item-
15075558.aspx”,
              “image”:
“https://cdn.trendii.com/_trendii_images_/310/fb04dc00ad7b385b66baedba66d5337
7.jpg”
            },
            {
              “id”: “2917035”,
              “name”: “Plan C - striped print shirt dress - women - Cotton - 40 - White”,
              “price”: “1923.00”,
              “sale”: false,
              “category”: “dress”,
              “currency”: “$”,
              “url”: “https://affiliate.trendii.com/affiliate-
link?affiliateId=310&utm_source=8d52c450-dee9-11eb-8943-
db8b0e077f69&utm_campaign=60daa49d02d0d9afec5ecdce&utm_term=2917035&utm
_content=60e4e23b1d55a42f0f198b4a&utm_medium=60b74492cad9572bb0169be2&re
directUrl=https%3A%2F%2Fprf.hn%2Fclick%2Fcamref%3A1101l9LGB%2Fcreativeref%
3A1101l18028%2Fdestination%3Ahttps%3A%2F%2Fwww.farfetch.com%2Fau%2Fshop
ping%2Fwomen%2Fplan-c-striped-print-shirt-dress-item-15325883.aspx”,
              “image”:
“https://cdn.trendii.com/_trendii_images_/310/f75a2201a244db62539d3d1adccd92ef
.jpg”
            },
        ],
        “advertiserName”: “FARFETCH”,
        “impressionId”: “8d52c450-dee9-11eb-8943-db8b0e077f69”,
        “creativeId”: “60e4e23b1d55a42f0f198b4a”
      }
    ]
}
```

In this example API response, data included in the API response includes: product ID; product details; product price; product category; currency; click through URLs. Data is provided for multiple products for display in the ad unit.

The content management module performs the content selection steps dynamically in real time. The process happens quickly so the content can be included into the ad unit during the webpage loading process at the browser. The content displayed in the ad unit is relevant to content of the page.

In embodiments in which the web server 100 interacts with the ad server platform 200, the ad server platform embeds SDK/Javascript on the webpage. The embedded SDK/Javascript extracts image data, either the image file itself, the image URL or the webpage URL, from the webpage. The ad server calls the interface API and provides the image data to the content management module. For ad servers which are not able to provide image data, a url of the publisher's webpage will be at least provided so content management module platform 300 will use that url to extract relevant images directly.

In embodiments, the position of the ad units on the webpage are provided to the content management module in the API request. As shown in the examples above, ad unit position information may be provided in an API request to the content management module.

For example, as shown in the API request below, the size and coordinates of the ad unit are provided in the API Request. Content management module uses the position information to determine which webpage content to analyse.

Content management module may also be presented with the position of images on the webpage. For example in FIG. 3, the webpage includes two images. The image URLs and image coordinates are provided in the API request. Content management module identifies the position of images on the webpage. Content management module determines the position of the ad unit relative to the positions of the images on the web page. The relative positions are used when selecting webpage content for analysis.

Thus users can see the products concurrently with the image. For example, a webpage may have two images, a first image and a second image, and a single ad unit which is displayed concurrently with the first image only. In this example, content selection platform 300 selects content for analysis that is displayed in the viewport with ad unit. Thus, when viewing the webpage, a user is presented with products directly related to the image while they are viewing the image and the products. This can create a more relevant shopping experience for the user since the products being displayed are relevant to the image being viewed.

For example, now referring to the following API request:

API request is:

```
″images″: {
  ″image1″: {
  ″image_url″: ″https://trendii
  products.storage.googleapis.com/_trendii_images_/129/a39358c3f7993c3f1682c5ae
  70c499b2.JPG?20200616″,
  ″image_coordinates″: ″100px, 1000px, 900px, 2000px″,
  image2″: {
  ″image_url″: ″https://trendii-
  products.storage.googleapis.com/_trendii_images_/129/a39358c3f7993c3f1682c5ae
  70c499b2.JPG?20200616″,
  ″image_coordinates″: ″2000px, 3000px, 900px, 2000px″,
  },
  ″ads_unit″: {
  “size”: “300x600”
  “coordinates”: ″100px, 1000px, 3000px, 4000px″,
  )
```

In the API request shown above, the coordinates for the ad unit are 100 px, 1000 px, 3000 px, 4000 px. The content management server identifies of the position of the ad unit appearing on the webpage.

The API request also presents the position of the images on the webpage. The API request identifies two images, namely image 1, positioned at 100 px, 1000 px, 900 px, 2000 px; and, image 2, positioned at 2000 px, 3000 px, 900 px, 2000 px.

In order to provide a more relevant consumer experience, content management module can determine the relative positions of the images on the webpage with respect to the ads unit. Preferably, products presented in the ad unit relate to items included in images which are concurrently visible in the viewport with the ad unit. This allows the user to view product options while viewing the image. When content management module 310 identifies multiple images in a API request it compares the coordinates of the images on the webpage with the coordinates of the ad unit. The content management module then selects an image for analysis depending on the location of the ad unit with respect to the image. In this step the content management module selects webpage content to analyse based on its location with respect to the ad unit. Webpage content displayed concurrently with the ad unit is rated more relevant that webpage content not displayed concurrently with the ad unit.

Referring now to FIG. 5, webpage 550 includes a first image 520 and a second image 560. In the example in which ads unit 530 is fixed in position on the webpage, image 520 is presented adjacent to ads unit 530. Image 560 is presented below the height of ads unit 530. Depending on the screen size that the user views the webpage, image 560 may not visible within the viewport when ads unit 530 is displayed to the user. If a user scrolls down on webpage 550 to bring the second image 560 into view, ads unit 530 is removed from view. Consequently, ads unit 530 is displayed concurrently with first image 520 but not displayed concurrently with image 2. In this scenario, it would be beneficial to present products relevant to first image 520 in ad unit 530. These relevant products can be viewed alongside image 520.

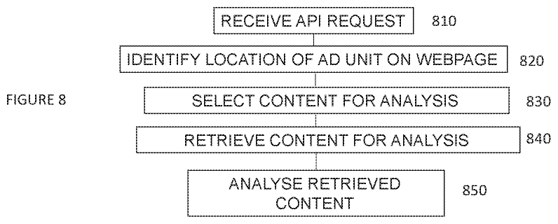

The additional steps of determining the location of the ads unit on the page and the location of images are performed at content management module 310 between the steps of retrieving images from webpage at 430 in FIG. 4 and analyzing the image at step 435. These steps are now described with reference to FIG. 8.

At step 810 content management module 310 receives a notification to provide content. At 820, content management module determines which webpage content is relevant for analysis. Content management module 310 performs this step by comparing the coordinates of the ad unit with the coordinates of content on the webpage. The content management module determines the location of the ad unit on the webpage. The coordinates of the ad unit may be provided in the notification, for example the API request. The content management module 310 determines the location of content on the webpage. The content may include images, text, video or other content types. If the webpage includes multiple images, the content management module determines the coordinates of the images on the webpage. The content management module may also determine the coordinates of text on the webpage. For text, the coordinates may relate to the text block.

Based on the relative coordinates of the content with respect to the ad unit, content management module selects content for analysis.

Content management module may be configured to select content for analysis based on its proximity to the ad unit. Such embodiments are configured to determine the closest content to the ad unit to be the most relevant. Content management module 310 calculates the distance between the content and the ad unit. Content management module 310 determines ranks the content based on its proximity to the ad unit. Content is selected for analysis based on its proximity to the ad unit. Closer content is ranked higher ranked higher in priority. The closest content is selected for analysis. Further filtering steps may be included for the content, for example, content management module may consider only images, or only text.

In an alternative embodiment, content management module is configured to select content based on its x or y coordinates on the webpage. Such embodiments are configured to determine content having closest x or y coordinates as the ad unit as being the most relevant content. In an example where the ad unit is positioned to the side of an image, the y coordinates are used to identify which image appears alongside the ad unit. Images, or other content, appearing alongside the ad unit are ranked higher in priority for analysis above images appearing above or below the ad unit.

At 830 priority content is selected for analysis. Content management module retrieves the priority content at 840. The content may be provided to content management module within the notification using a URL or by including other file details in the notification, or content is retrieved from the URL for the webpage by scraping the webpage and retrieving the content.

In the example where the priority content is an image, and the application is a fashion application, at 850 the priority image is analysed to identify fashion items in the image. As described above, items identified in the image are matched against images in a content database. Product data is retrieved for the matched images and provided in a response. The response may be an API response.

The example above describes selection of priority images for analysis. It will be understood that other content, including text, video, may also be considered in the content selection step. For example, text data may be prioritized above image data in certain scenarios.

In a further example, the webpage may include a ‘floating’ ad unit. Floating ad units move up and down the webpage as a user scrolls up and down the page, so they remain in the user viewport. In some embodiments the ad unit is configured to maintain a constant position in the viewport when viewed by a user. Floating ad units are not fixed to a single position on the page.

In some embodiments, content management module 310 retrieves position data for images on the webpage. Ranking algorithm can optimize the product recommendation and ranking for different images.

The content analysed by content management module depends on the configuration of the ad tag. In some embodiments, for example native ad tags, the ad tag issues a URL each time it detects content being moved into the user viewport. With native URLs, the ad unit is automatically created next to the content, for example placed below the content on the webpage. For the case of the native ad tag, identification of the relevant content is provided in the notification, for example the image URL. Since the ad tag is triggered each time content is brought into view on the viewport the content management module is aware that that he relevant content for analysis is the content included in the ad tag.

Programmatic ad tags may provide additional information, including the coordinates of the ad tag, the size of the viewport and the webpage URL. As described above, the content management system retrieves the webpage data and determines the coordinates of content on the webpage to identify the most relevant content for analysis. This selection may be made based on various criteria or filters, for example, proximity, x or y coordinate or content type. One further step the content management module may perform is to simulate the user's viewport. When the content management module is provided with viewport size data it simulates the viewport on the webpage to determine which content is displayed within the viewport concurrently with the ad unit.

The notification response, for example API response, including the relevant product information can associate different product recommendations to different positions of the webpage. This information can be included in the API response. So as a user scrolls through the page, different sections of the webpage come into view and different images come into view. Different product recommendations are provided into the ad unit as the different images come into view. In these embodiments, products in the ad unit are updated as a user views different sections of the webpage so as different images are viewed, different products are rendered within the ad unit, so relevant products can be viewed concurrently with the image. In these embodiments, ad unit javascript will update content automatically according to where the user is at on the page.

Product information may be provided to the ad unit in a floating ad unit embodiment using different methods. In one embodiment, ad code, for example an ad tag, on the browser monitors the visibility change of every image on the web page. When an image moves into the viewport, the ad tag will trigger the API request for that particular image and render the ads accordingly based on the response data.

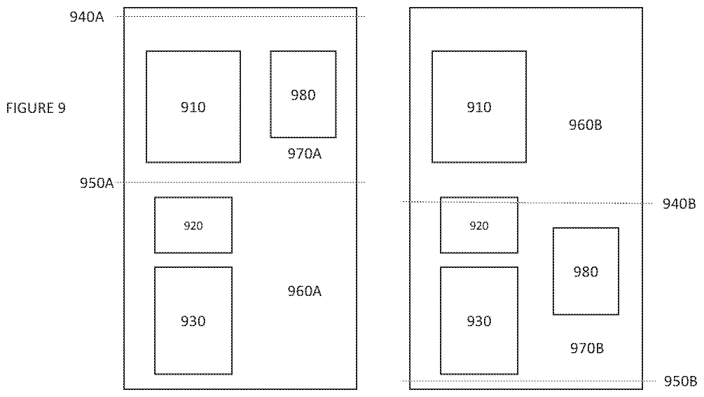

A floating ad unit and the steps taken in relation to providing product data for display in the ad unit are now described with respect to FIG. 9. FIG. 9 shows webpage 900. Webpage 900 includes a first image 910, text block 920 and second image 930. First image is organized on the webpage above text block 920. Text block 920 is arranged above second image 930.

When viewed in a browser, only a portion of webpage 900 is visible at any time. The visible area of the webpage is illustrated between top boundary 940 and lower boundary 950. Hashed area 960 is not visible to the user.

Ad unit 980 is arranged to remain within the viewport regardless of which sections of the webpage are currently being viewed by the user.

Boundary lines 940 and 950 define region 970 visible within viewport.

In FIG. 9A, the top portion of the webpage 900 between 940A and 950A is visible on a user's display, indicated by 970A. Hashed position 960 of webpage 900 is not visible. Ad unit 920 is within visible portion 970A. In FIG. 9A, first image 910 and ad unit 980 is included within visible portion 970A. Second image 930 and text block 920 are outside the visible portion of the webpage.

Ad tag within HTML file for the webpage 900 monitors which portions of the webpage are visible, i.e. in the user's viewport. In FIG. 9A, ad tag triggers an API request for content for ad unit 920 and provides the URL of image 910 only, since image 930 and text block 920 are not within the user viewport.

API request triggers content management platform to select content for ad unit. This process for retrieving product data for display in ad unit 980 is performed in the same manner described above when the request is received at content management module 310. For example, image URL for image 910 or other information relevant to webpage 900 or image 910 is provided within the API request. The API request is provided to the content management server. The content management server selects image 910 for analysis, analyses image 910 and provides relevant product details in an API response. The webpage renders the ads accordingly in ad unit 980 based on the response data.

As the user scrolls up and down webpage 900, different sections of webpage 900 are brought into view. Ad tag monitors the change in viewing area of the webpage.

In FIG. 9B, the user has scrolled down webpage 900 from the position shown in FIG. 9A. Bottom portion of webpage 900 between 940B and 950B is now visible on the user's viewport, indicated by 970B. Hashed position 960B of webpage 900 is not visible and outside the viewport. Ad unit 920 remains within the viewport 970B. In FIG. 9B, first image 910 is now within non-visible portion of the webpage and not visible to the user. Second image 930 and text block 920 are included within visible portion 970B and is visible to the user. Second image 930 is outside the visible portion of the webpage. As shown in FIG. 9B, ad unit 980 is repositioned on webpage 900 and now appears along side second image 930.

Ad tag within HTML file for the webpage 900 monitors this change in visible section of webpage 900 on the user display. In FIG. 9B, ad tag identifies that the viewed portion of webpage 900 has changed and that second image 930 and text block 920 are now presented on the user display. Ad tag triggers a new API request for content for ad unit 920 and provides the URL of image 930 only, since image 910 is now not visible to the user.

Again, the process for retrieving product data for display in ad unit 980 is performed in the manner described above. Image URL for image 930 or other information relevant to webpage 900 or image 930 is provided within the API request. The API request is provided to the content management server. The content management server selects image 930 for analysis, analyses the image and provides relevant product details in an API response. The webpage renders the ads accordingly in ad unit 980 based on the response data.

For further embodiments having additional images, further API requests can be sent to retrieve further product data for display in ad unit 980.

In some embodiments, each time an image is brought into view within a user's viewport the ad tag triggers a new API request for product data to display in the ad unit. In other embodiments, ad triggers an API request for product data the first time an image is brought into view within a user's viewport. The data provided in the API response is stored and can be presented again if the user returns to an image after scrolling through an image on the webpage.

Embodiments using floating ad units enable product adverts to be updated as a user views different images on his viewport, within a single webpage. An advantage of these embodiments is that a user is always presented with product data relevant to an image which is currently being displayed in the viewport. This concurrent viewing of an image with relevant product data improves user experience.

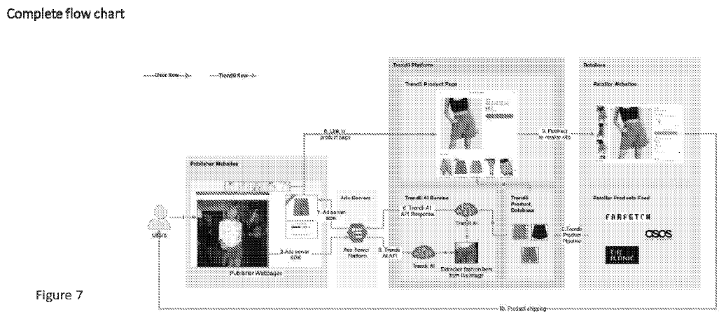

FIG. 7 shows the architecture and functional steps in a further embodiment. The steps shown in FIG. 7 are as follows:

Step 1: User landed on any publishers' webpages. User accesses the webpage from a user device. The user's browser application on the user device retrieves the content of the selected webpage from the publisher's website server. The content includes the HTML file for the webpage. The HTML file includes content, web addresses for further content incorporated into the webpage, for example images, and ad tag associated with an ad unit on the page.

Step 2: When rendering the page on the user device, ad servers embedded SDK/Javascript extracts all images and ad units from the webpage.

Step 3: Ad server call content management server's AI ads API and provides the following data or objects based on any industry standard frameworks (e.g. OpenRTB): Page URL; Images and their locations of the page; Ad units and their locations of the page; Ad unit types (e.g. floating, fixed etc.). This API request serves as a request for product content.

Step 4: Content management system's object detection AI API retrieves image data or other webpage data identified in the API request. Image data may be retrieved in different ways. If the API request includes an image identifier, for example a URL address for the image, content management server retrieves the image from the image source, via the internet. If the webpage address is included in the API request, for example the URL address of the webpage, content management server accesses the webpage and scrapes the webpage to retrieve the image. When the image file is retrieved, the image is provided to an AI extraction server 320. AI extraction server analyses the image file and extracts the fashion items (or other items indicated by ad server) from the image. In the example of FIG. 7, the image on the website is a photograph of a female and includes multiple items including shorts, shirt, bag. AI extraction server analyses the image and identifies and extracts items from the image. In the example of FIG. 7, the AI algorithm is a fashion algorithm. The AI algorithm is trained to identify and extract fashion items.

Step 5: Matching server receives extracted items from AI extraction server (step 4). The product matching AI search/matches the extracted fashion items against items stored in a product database. Millions of products may be stored in the product database.

Step 6: Matching server's product matching AI ranks the top relevant products. Ranking can be performed based on similarity of the product to the item. Product matching platform transmits the product data back to Ad servers. Typically a transceiver is used. Preferably the products are transmitted within an API response (same API as step 3). The response includes: A list of product ads for every ad unit in the page; and/or, for floating ad unit, content selection platform will provide a list of ads together with triggering locations so content-related ads will be shown dynamically and responsively when users reach different location of the page.

Step 7: Ad server receives product ads from the product matching platform. Product ads are allocated to relevant ad unit in the publishers webpage that the user is browsing.

Step 8: Product ads are displayed in the relevant ad unit on the web page. Users browse the webpage. When users click thru the ads they are redirected to the product page. The product page may be associated with the product matching platform.

Step 9: Users browse the product information at product matching platform's page and click through to the retailer site to complete the transaction.

Step 10: Retailers ship the products to the users

* Step 0: Product matching platform's product pipelines are gathering millions of products from retailers over the world and continuously updating the products for advertising. These products may be stored in the Product Database of the product matching platform.

The examples provided above are directed to providing ads based on image content of a webpage. The invention is not limited to matching images with products. Further embodiments can provide relevant content based on the text of the website or other content included on the webpage. When receiving the API request content management module accesses the relevant content. Content may include one or more images, as described above. Content may include video. Content may include text. On accessing the content management module is configured to analyse the content to identify items. These items are then matched to products in the product database to identify products for display on the webpage. The identified products are then notified to ads server to be incorporated into the ad units on the webpage.

In the embodiments described above, products are presented associated with fashion items identified in the images of the webpage. It will be clear to those skilled in the art that applications for the invention extend beyond fashion items. Embodiments of the invention can identify any recognizable product in an image and extract relevant product information for display on the webpage. Such embodiments may include homewares, furniture, sports equipment, or any other type of recognizable product. In such embodiments, the analysis algorithms within the product matching platform are trained to identify relevant items.

Further embodiments are not limited to providing product information only. Such embodiment may provide, for example, brand information. Brands may associate with different products or objects identified in an image. In such cases, ranking algorithm may match brands to particular images and provide links or other brand related content for display on the webpage.

In the process of providing product, or other, information for display on the webpage, interface server may include a bid request associated with the product or other information for display.

Embodiments of the invention provide a means to present relevant content on a website, in the form of adverts, product information, or other contextual information, which relates to the webpage content. In particular, embodiments select content based on images presented on a webpage. Embodiments of the invention identify images presented on a webpage and retrieve relevant content for display based on the images. Further embodiments recommend content for display based on the display position on the webpage of the image and the content, in such embodiments relevant content is displayed concurrently with the image.

Embodiments communicate with webpages dynamically to enable time relevant content to be presented on the webpage to users.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, namely, to specify the presence of the stated features but not to preclude the presence or addition of further features in various embodiments of the invention.

It is to be understood that the aforegoing description refers merely to preferred embodiments of invention, and that variations and modifications will be possible thereto without departing from the spirit and scope of the invention, the ambit of which is to be determined from the following claims.

1. A content selection platform for selecting content for display on a webpage, comprising the steps of:
identifying webpage data, webpage data being data presented on a webpage;
analysing the webpage data;
retrieving content related to the webpage data from a content database; and,
providing the retrieved content in order that the retrieved content to be inserted into the webpage for display at a display position on the webpage.

2. A content selection platform according to claim 1 wherein the step of analysing the webpage data comprises the step of identifying at least one characteristic of the webpage data.

3. A content selection platform according to claim 2 wherein the step of retrieving content is performed by matching the webpage data with content stored within a content database to select and retrieve content related to the webpage data, the matching being performed based on the at least one identified characteristic of the webpage data.

4. (canceled)

5. (canceled)

6. A content selection platform according to claim 1 wherein the webpage data is an image, the image being analysed to identify characteristics within the image, the characteristics being associated with items in the image, the characteristics being matched to product data stored in the content database to identify product data associated with the items in the image, the matching product data being provided for display at a display position on the webpage.

7. A content selection platform according to claim 1 wherein the step of identifying webpage data is performed in response to receiving a trigger signal.

8. A content selection platform according to claim 7 wherein the trigger signal is received in response to the webpage being loaded on a user device.

9. A content selection platform according to claim 7 wherein the steps of identifying the webpage data, analysing the webpage data, retrieving content and providing the retrieved content are performed dynamically upon receipt of the trigger signal.

10. A content selection platform according to claim 1 comprising the further step of determining the location of the display position on webpage.

11. A content selection platform according to claim 1 comprising the further step of determining the position of webpage data on the webpage and selecting at least one portion of the webpage data for analysis, wherein selection is made in dependence on the location of the webpage data with respect to the display position for the retrieved content on the webpage.

12. A content selection platform according to claim 11 wherein the at least one portion of the webpage data selected for analysis is selected based on its proximity to the display position of the retrieved content.

13. A content selection platform according to claim 11 comprising the further step of determining a portion of the webpage data displayed within a viewport of a user device, and selecting the portion of webpage data for analysis in dependence on it being displayed within the viewport of the user device.

14. A content selection platform according to claim 13 wherein the display position of the retrieved content on the website is within a viewport of the user device and the analysed webpage data and the retrieved content are displayed concurrently within the viewport of the user device.

15. A content selection platform for selecting content for display on a webpage, comprising:
data retrieving server for identifying webpage data, webpage data being data presented on a webpage;
data analysis server for analysing the webpage data;
content matching server for retrieving content related to the webpage data from a content database; and, providing the retrieved content in order that the retrieved content can be inserted into the webpage for display at a display position on the webpage.

16. A content selection platform according to claim 15 wherein the content analysis server performs the step of analysing the webpage data by identifying at least one characteristic of the webpage data.

17. A content selection platform according to claim 16 wherein the content matching server performs the step of retrieving content by matching the webpage data with content stored within a content database to select and retrieve content related to the webpage data, the matching being performed based on the at least one identified characteristic of the webpage data.

18. (canceled)

19. (canceled)

20. A content selection platform according to claim 15 wherein the webpage data is an image, the image being analysed to identify characteristics within the image, the characteristics being associated with items in the image, the characteristics being matched to product data stored in the content database to identify product data associated with the items in the image, the matching product data being provided for display at a display position on the webpage.

21. (canceled)

22. (canceled)

23. (canceled)

24. (canceled)

25. A content selection platform according to claim 15 comprising means for determining the position of the webpage data on the webpage and selecting at least a portion of the webpage data for analysis, wherein the selection is made based on the location of the webpage data with respect to the display position.

26. (canceled)

27. A content selection platform according to claim 15 comprising means for determining the webpage data displayed within a viewport of a user device, and selecting the webpage data for analysis in dependence on it being displayed within the viewport of the user device.

28. A content selection platform according to claim 15 wherein the display position of the retrieved content on the website is within a viewport of the user device and the analysed webpage data and the retrieved content are displayed concurrently within the viewport of the user device.

29. A content selection platform for selecting content for insertion on a webpage, comprising the steps of: receiving data identifying an image on webpage; retrieving content related to the image from a content database; providing the content to be inserted into the webpage for display at a display position.
